(19) United States
(12) Patent Application Publication
(10) Pub. No.: US 2005/0277453 A1
(43) Pub. Date: Dec. 15, 2005

(54) Mobile phone having mirror and light

(76) Inventor: Chong Taek Kim, Upland, CA (US)

Correspondence Address: Jerry H. Noh;Suite 2741, 3435 Wilshire Blvd, Los Angeles, CA, 90010, US

(21) Appl. No.: 10/864,246

(22) Filed: Jun. 9, 2004

(51) Int. Cl. H04M 11/00

(52) U.S. Cl. 455/575.8; 455/575.1

(57) ABSTRACT

A mobile phone having a keypad arrangement and display formed on a housing unit. The housing unit having a battery compartment defined therein for housing a power supply and covered by a cover plate. A mirror being placed on a concealable portion of the housing unit. The concealable portion of the housing unit being the inner surface of the cover plate. The cover plate being mounted to slide interchangeably between an open position in which the battery compartment and mirror are revealed and a closed position in which the battery compartment and mirror are both concealed. In another embodiment, the concealable portion of the housing unit being the inner surface of a keypad cover unit formed and arranged on the housing unit to cover at least the keypad arrangement. The keypad cover unit being mounted to move interchangeably between an open position in which both the mirror and keypad arrangement are revealed and a closed position in which both the mirror and keypad arrangement are concealed. A light emitting device being placed adjacent the mirror for illuminating the area around the mirror.

### BACKGROUND OF THE INVENTION

1. Field of the Invention

This invention relates to mobile phones, and more particularly, this invention relates to mobile phones having a mirror and light.

2. Description of the Prior Art

There are many different types of mobile phones. Most functional mobile phones have a display, keypad arrangement, power supply, battery compartment, and battery compartment cover. Some phones have a keypad cover which slideably mounts onto the phone for covering and uncovering at least the keypad arrangement. Other phones have a keypad cover which in hingeably mounted on the phone to fold onto and over the keypad arrangement, or away from the keypad arrangement. No known mobile phone has a mirror formed thereon. Mirrors are convenient items often carried by women in a safe housing which protects the mirror from being broken when not in use. Women often carry compact mirrors in their purses, which they can use to see desired parts of themselves as necessary. Men do not commonly carry a portable mirror as it would be inconvenient for them to do so without carrying a bag, purse, or a handbag. Both men and women, however, do carry mobile phones. It would be desirable for a mobile phone to have a mirror safely placed at a convenient part thereof. In addition, there is no known mobile phone having a light emitting device as taught in the present invention.

### SUMMARY OF THE INVENTION

It is a primary objective of the present invention to provide a mobile phone having a mirror placed thereon. It is another objective of the present invention to provide such a mirror on a concealable portion of the mobile phone. It is another objective of the present invention to provide a mobile phone having a light emitting device in the form of a flashlight.

The present invention is a functional mobile phone having a keypad arrangement and display formed on a housing unit. The keypad arrangement consists of a plurality of keypads for operating the functions of the mobile phone. The housing unit has a battery compartment defined therein for housing a power supply, which supplies power for the various predetermined functions of the mobile phone. The mobile phone further has a mirror placed on a concealable portion of the housing unit. The concealable portion of the housing unit can be an inner surface of a cover plate arranged and formed on the housing unit to cover the battery compartment. The cover plate is mounted to slide interchangeably between an open position in which the battery compartment and mirror are revealed and a closed position in which the battery compartment and mirror are both concealed.

In another embodiment, the concealable portion of the housing unit is the inner surface of a keypad cover unit formed and arranged on the housing unit to cover at least the keypad arrangement. The keypad cover unit is mounted to move interchangeably between an open position in which both the mirror and keypad arrangement are revealed and a closed position in which both the mirror and keypad arrangement are concealed.

The mobile phone further has a light emitting device placed adjacent the mirror for illuminating the area around the mirror. Also, the mobile phone further has a second light emitting device in the form of a flashlight formed on the housing unit. A switch is formed on the housing unit for controlling the on/off function of the second light emitting device.

### BRIEF DESCRIPTION OF THE DRAWINGS

With the above and additional objects and advantages in view, as will hereinafter appear, this invention comprises the devices, combinations and arrangements of parts hereinafter described, by way of example, and illustrated in the accompanying drawings of a preferred embodiment in which:

FIG. 1 is a top perspective view of the present invention illustrating the cover plate in an open position;

FIG. 2 is a side elevational view of the present invention illustrating the cover plate in a closed position a having portion of the housing cut-away;

FIG. 3 is a top perspective view of a second embodiment of the present invention;

FIG. 4 is a top perspective view of a third embodiment of the present invention illustrating the keypad cover unit in a closed position;

FIG. 5 is a top perspective view of the third embodiment of the present invention illustrating the keypad cover unit in an open position;

FIG. 6 is a side elevational view of a fourth embodiment of the present invention illustrating the keypad cover unit in an open position; and,

FIG. 7 is a side elevational view of the fourth embodiment of the present invention illustrating the keypad cover unit in a closed position.

### DETAILED DESCRIPTION OF THE INVENTION

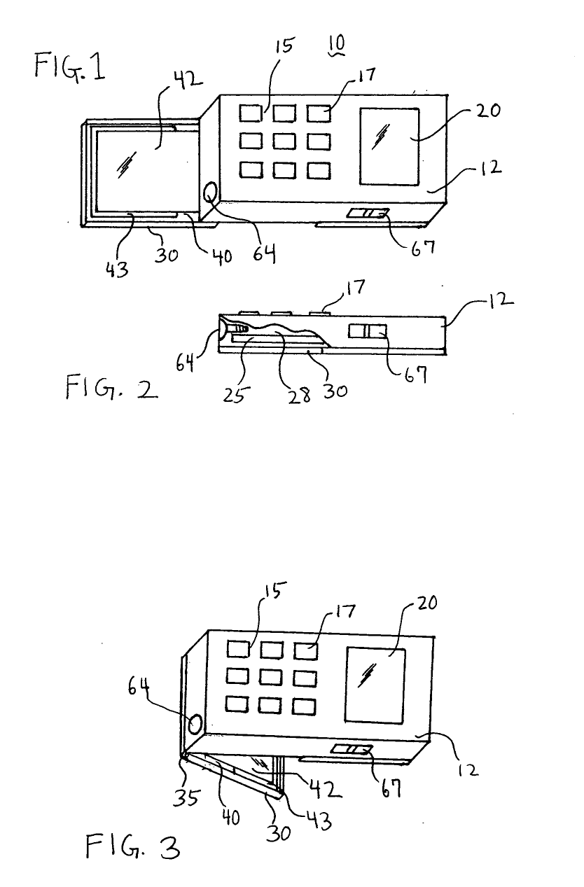

The present invention as shown in FIGS. 1 and 2 is a functional mobile phone 10 having a keypad arrangement 15 and display 20 formed on a housing unit 12. The keypad arrangement has 15 a plurality of keypads 17 for operating the functions of the mobile phone 10. The display 20 illustrates the various predetermined operations of the phone. The housing unit 12 further contains a power supply 25 for supplying power to the mobile phone 10. The power supply 25 is positioned within a battery compartment 28 defined within the housing unit 12. A cover plate 30 is arranged and formed on the housing unit 12 to cover the battery compartment 28. The cover plate 30 is removeable and slides interchangeably between an open position as shown in FIG. 1 and a closed position as shown in FIG. 2. In the closed position, the cover plate 30 covers the battery compartment 28, and in the open position, the cover plate 30 extends outward from the housing unit 12. In the alternative, as shown in FIG. 3, the cover plate 30 can be hingeably connected to the housing unit 12 at a hinge point 35 to fold away from the housing unit 12 and also to fold onto the housing unit 12 to cover the battery compartment 28. In another alternative, not illustrated, the cover plate 30 can be hingeably connected to rotate at a single hinge point both away from the housing unit 12 to reveal the batter compartment and toward the housing unit 12 to cover the battery compartment 28. The cover plate 30 has an inner surface 40; the inner surface 40 being the surface facing the battery compartment 28 when the cover plate 30 is covering the battery compartment 28. The mobile phone further has a mirror 42 placed on the inner surface 40 of the cover plate 30.

For illuminating the area around the mirror 42, the mobile phone further has a light emitting device 43 placed adjacent the mirror 42. The power for illuminating the light emitting device 43 is supplied by the power supply 25.

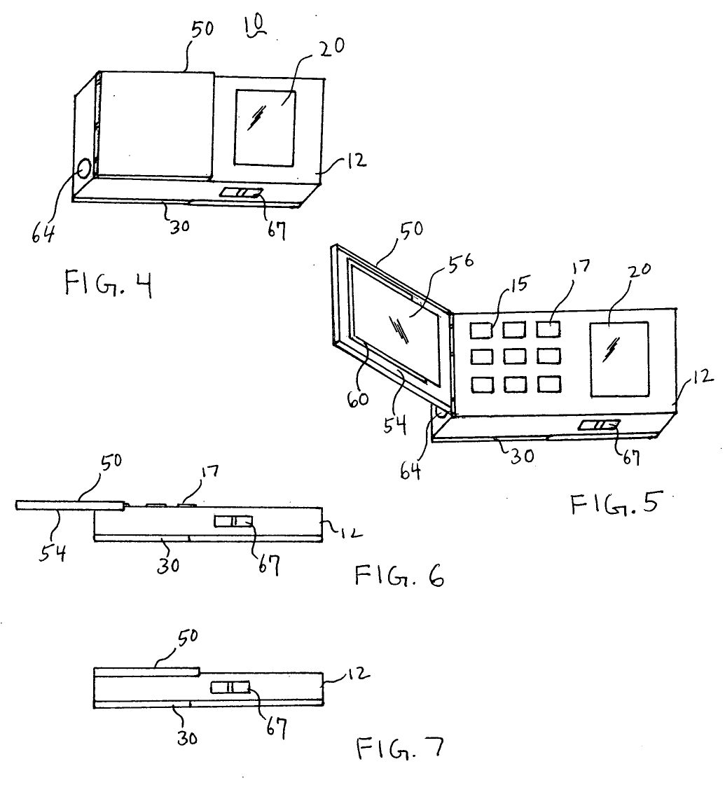

In another embodiment, the present invention as shown in FIG. 4 to 7 is a functional mobile phone 10 having a keypad arrangement 15 and display 20 formed on the housing unit 12. The keypad arrangement has 15 a plurality of keypads 17 for operating the functions of the mobile phone 10. The display 20 illustrates the various predetermined operations of the phone. The housing unit 12 further contains a power supply 25 for supplying power to the mobile phone 10. The power supply 25 is positioned within a battery compartment 28 defined within the housing unit 12. A cover plate 30 is arranged and formed on the housing unit 12 to cover the battery compartment. In this embodiment, a keypad cover unit 50 is placed on the housing unit 12 to cover at least the keypad arrangement 15. The keypad cover unit 50 can be hingeably mounted on the housing unit as shown in FIGS. 4 and 5, and in the alternative, the keypad cover unit 50 can be slideably mounted on the housing unit as shown in FIGS. 6 and 7. In FIGS. 4 and 5, the keypad cover unit 50 folds towards the keypad arrangement 15 to a closed position as shown in FIG. 4 and folds away from the keypad arrangement 15 to an open position as shown in FIG. 5. In FIGS. 6 and 7, the keypad cover unit 50 slides interchangeably between an open position as shown in FIG. 6 and a closed position as shown in FIG. 7. The keypad cover unit 50 has an inner surface 54 facing the keypad arrangement 15 when said keypad cover unit 50 covers the keypad arrangement 15. A mirror 56 is placed on inner surface 54 of the keypad cover unit 50. In the closed position, the keypad cover unit 15 covers at least the keypad arrangement and conceals the mirror 56; whereas, in the open position, the keypad arrangement 15 and the mirror 56 are both revealed and accessible to the user.

For illuminating the area around the mirror 56, the mobile phone further has a light emitting device 60 placed adjacent the mirror 56. The power for illuminating the light emitting device is supplied by the power supply 25.

For all embodiments shown in FIG. 1 to 7, the mobile phone can further have a second light emitting device 64 in the form of a flashlight placed on the housing unit 12. A separate switch 67 can be placed on the housing unit 12 to control the on/off function of the second light emitting device 64. The power for illuminating the second light emitting device is also supplied by the power supply 25.

While embodiments of the invention has been described and illustrated for purposes of clarity and example, it should be understood that many changes, substitutions and modifications to the described embodiment will be apparent to those having skill in the art in light of the foregoing disclosure without departing from the scope and spirit of the present invention which is defined by the claims which will follow.

1. A mobile phone comprising:
a housing unit;
a keypad arrangement formed on said housing unit;
a display formed on said housing unit;
a battery compartment formed within said housing unit;
a cover plate arranged and formed on said housing unit to cover said battery compartment, said cover plate having an inner surface facing said battery compartment; and,
a mirror disposed on said inner surface of said cover plate.

2. The mobile phone as described in claim 1 wherein said cover plate is formed to slide between a closed position and open position;
wherein said closed position, the cover plate completely covers said battery compartment to hide the mirror; and,
wherein said open position, the cover plate extends outward from the housing unit to reveal the mirror.

3. The mobile phone as described in claim 1 wherein said cover plate is hingeably mounted onto said housing unit.

4. The mobile phone as described in claim 1 further comprising a light emitting device disposed adjacent said mirror and a power supply unit for supplying power to the light emitting device.

5. A mobile phone comprising:
a housing unit;
a keypad arrangement formed on said housing unit;
a display formed on said housing unit;
a keypad cover unit disposed on said housing unit to cover at least said keypad arrangement, said keypad cover unit having an inner surface facing said keypad arrangement when said keypad cover unit covers said keypad arrangement; and,
a mirror disposed on said inner surface of said cover plate.

6. The mobile phone as described in claim 5 wherein said keypad cover unit is formed to slide between a closed position and open position;
wherein said closed position, the keypad cover unit covers at least said keypad arrangement to conceal the mirror; and,
wherein said open position, the keypad cover unit extends outward from the housing unit to reveal the mirror.

7. The mobile phone as described in claim 5 wherein said keypad cover unit is hingeably mounted onto said housing unit.

8. The mobile phone as described in claim 5 further comprising a light emitting device disposed adjacent said mirror and a power supply unit for supplying power to the light emitting device.

9. In a mobile phone comprising a housing unit, a keypad arrangement and display formed on said housing unit, with said improvement comprising;
a light emitting device formed on said housing unit to function as a flashlight;
a power supply unit for supplying power to the light emitting device; and,
a switch formed on the housing unit for activating and deactivating the light emitting device.

10. The mobile phone as described in claim 9 further comprising a keypad cover unit disposed on said housing unit to cover at least said keypad arrangement, said keypad cover unit having an inner surface facing said keypad arrangement when said keypad cover unit covers said keypad arrangement; and,
a mirror disposed on said inner surface of said cover plate.

11. The mobile phone as described in claim 9 further comprising:
a battery compartment formed within said housing unit;
a cover plate arranged and formed on said housing unit to cover said battery compartment, said cover plate having an inner surface facing said battery compartment; and,
a mirror disposed on said inner surface of said cover plate.
